(19) United States
(12) Patent Application Publication
(10) Pub. No.: US 2009/0191857 A1
(43) Pub. Date: Jul. 30, 2009

(54) Universal subscriber identity module provisioning for machine-to-machine communications

(75) Inventors: Gunther Horn, Munchen (DE); Mikko J. Kanerva, Helsinki (FI); Luc De Bie, Deurne (BE); Silke Holtmanns, Klaukkala (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignees: Nokia Siemens Networks Oy; Nokia Corporation

(21) Appl. No.: 12/010,889

(22) Filed: Jan. 30, 2008

(51) Int. Cl. H04M 3/00

(52) U.S. Cl. 455/419

(57) ABSTRACT

The present invention relates to remotely provisioning subscriber identification parameters in a device on a wireless network. A secure connection is established with the device, and a token containing the new subscriber identification parameters is forwarded over the secure connection. The device may verify the received token. In one embodiment, the subscriber identification parameters are updated to change network operators. The secure connection can be with the old network operator or the new network operator. The device on the wireless network may be a machine-to-machine device. The provisioned subscriber identification may be part of a universal subscriber identification module.

### BACKGROUND OF THE INVENTION

1. Field of the Invention

The present invention generally relates to a system and method for remotely modifying device configurations such as machine subscriptions such that that the credentials of those subscriptions (algorithms, keys) may be implemented in a secure environment.

2. Description of the Related Art

General requirements and use cases are being developed, for example, by the third generation partnership project (3GPP) SA3 (the Security Working Group), to facilitate machine-to-machine (M2M) communication in 3GPP-defined mobile communication systems, and remote management and configuration of M2M terminals. For purposes of the present application, M2M communication is defined by the fact that an M2M terminal, which can be a terminal communicating over 3GPP or similar wireless network, does not have to be attended by a human user.

A universal subscriber identity module ((U)SIM) is an application for the universal mobile telephone system (UMTS) mobile telephony running on a Universal Integrated Circuit Card (UICC) smart card which is inserted in a 3G mobile phone. The (U)SIM is a logical entity on the physical card that stores user subscriber information, authentication information and provides storage space for text messages and phone book contacts and that includes an enhanced phone book. For authentication purposes, the (U)SIM stores a long-term pre-shared secret key K, which is shared with the Authentication Center (AuC) in an associated wireless network. The (U)SIM also verifies a sequence number that can be within a range using a window mechanism to avoid replay attacks, and is in charge of generating the session keys CK and IK to be used in the confidentiality and integrity algorithms, such as a KASUMI, or A5/3, block cipher in UMTS.

M2M terminals differ from typical mobile terminals (MS) in that the owner does not necessarily have easy access to the M2M terminals. As described in greater detail below, a M2M terminal may be used to track a moving product. An M2M terminal may also be used for metering, for example, to automatically transmit utility use data from a household.

Because the M2M terminal is not attended by a person, some current procedures related to the handling of the (U)SIM implemented on a smart card (UICC) may be cumbersome and costly. Therefore, there is a need for new or modified procedures to make M2M communication viable in the market at a large scale.

For example, in the conventional networks configurations, a physical (U)SIM change is used to realize a change of a service provider subscription. For the M2M case, this physical (U)SIM change is usually not a viable option, because of the amount of (U)SIM to be changed, the terminals could be distributed all over the country, and/or the (U)SIM may be physically inaccessible in the M2M terminal. For example, M2M-based meters may be distributed over thousands of houses and each of these MSM-based meters is typically secured and hidden in the meter to avoid tampering and manipulation.

A problem to be solved then becomes how to securely update a (U)SIM, so that it may become an authentication device for another network. At the same time, an M2M operator wants to avoid any situation, in which he needs to reveal security relevant data to a third party.

In other situations, it is known to modify network usage by updating of parameters in a Home Subscriber Server (HSS), also known as a Home Location Register (HLR) or a User Profile Server Function (UPSF). The HSS is a master user database that supports the IMS network entities that actually handle calls. In particular, the HSS contains the subscription-related information (user profiles), performs authentication and authorization of the user, and can provide information about the user's physical location.

In the field of computing, a Trusted Platform Module (TPM) can be used to authenticate hardware devices. Since each TPM chip has a unique and secret RSA key burned in during the production, it is capable of performing platform authentication. For example, it can be used to verify that the system seeking the access is the expected system. The TPM offers facilities for secure generation of cryptographic keys, the ability to limit the use of cryptographic keys, as well as a hardware random number generator. The TPM also includes capabilities such as remote attestation and sealed storage. Remote attestation creates a hash key summary of the hardware and software, and the extent that the software is being summarized is decided by the software that is encrypting the data. This configuration allows a third party to verify, for example, that the software has not been changed. Either sealing or binding techniques may be used in a TPM. Sealing techniques are used to encrypt data such that it may be decrypted only if the TPM releases the right decryption key, which occurs only if the exact same software is present as when it encrypted the data. Binding techniques encrypt data using the TPM's endorsement key, a unique RSA key burned into the chip during its production, or another trusted key.

### SUMMARY OF THE INVENTION

In one embodiment, a method remotely updates stored subscriber identification parameters over a wireless network. The method includes establishing new parameters from a new operator for updating stored subscriber identification, and checking the integrity of the new parameters using data received from an old network operator. Then, an existing connection to the network is stopped and the connection is reestablished using the new parameters.

The new parameters may relate to a new network operator. The establishing of the new parameters may include storing the new parameters in parallel to the stored parameters and prioritizing the new parameters. The method may further include receiving authorization to update the parameters. The receiving of the authorization to update the parameters may include accepting a secure connection from the old network operator, receiving a token from the old network operator, where the token includes the new parameters, and verifying the token. The token may include an identifier of the new network operator, and where the verifying of the token includes analyzing the identifier. The new parameters may result in a change from the current network operator to a new network operator.

The method may be performed by a machine-to-machine terminal and/or by multiple devices. The new parameters may include changes in a universal subscriber identity module. Also, the new parameters may result in a change from the old network operator to the new network operator.

The method may further include forwarding a first random number, receiving a second random number, accepting a secure connection based on the first and second random numbers, and receiving the new parameters over the secure connection. The second random number may be produced by a new network operator, and where a computer associated with an owner of the device exchanges the both the first and the second random numbers between the device and the new network operator.

In another embodiment, an apparatus for remotely updating stored subscriber identification parameters over a wireless network. The apparatus includes a storage device configured to store the subscriber identification parameters. A processor configured to establishing new parameters for updating subscriber identification and to check the integrity of the new parameters using data received from a current network operator. A transmitter configured to stop a connection to the network and to reestablish the connection using the new parameters. The apparatus may be machine-to-machine terminal. For example, the apparatus may be a meter or a tracking device. The new parameters may include changes in a universal subscriber identity module stored in the apparatus.

The storage device is further configured to store the new parameters in parallel to the stored parameters to prioritize the new parameters. The storage device may also be configured to remove the new parameters, and where the transmitter is further configured to restore the connection to the network using the stored parameters.

The apparatus may further including a receiver configured to receiving authorization to update the parameters. The receiver may be further configured to accept a secure connection from the current network operator, and to receive a token from the current network operator, where the token includes the new parameters; and where the processor is configured to verify the token. The token may include an identifier of a new network operator, and where the processor verifies the token by analyzing the identifier.

The processor may be configured to produce a first random number and a transmitter is configured to send the first random number to the network. The receiver may be configured to receive a second random number, accepts a secure connection based on the first and second random numbers; receives the new parameters over the secure connection. The second random number may be produced by a new network operator, and a computer associated with an owner of the apparatus may exchange the both the first and the second random numbers between the apparatus and the new network operator.

In another embodiment, a method for remotely updating stored subscriber identification parameters over a wireless network includes accepting a secure connection from new network operator and establishing new parameters for updating stored subscriber identification, where the new parameters are received from the new network operator over the secure connection. The method continues with checking integrity of the new parameters, stopping a connection to the network, and reestablishing the connection using the new parameters. The method may be performed by a machine-to-machine terminal or by multiple devices. The new parameters include changes in a universal subscriber identity module. For example, the new parameters may result in a change from an old network operator to the new network operator.

The establishing of the new parameters may include storing the new parameters in parallel to the stored parameters and prioritizing the new parameters. The accepting of the secure connection may includes computing a session key using either a hash or a reverse hash, establishing an authentication and key agreement, or using public key cryptography with private and public signing keys.

The receiving of the authorization to update the parameters may include receiving a token, where the token includes the new parameters and verifying the token. The token may include an identifier of the new network operator, and the verifying of the token includes analyzing the identifier.

In another embodiment, an apparatus is configured for remote updating of stored subscriber identification parameters over a wireless network. The apparatus includes a receiver configured to accept a secure connection from new network operator, a processor configured to establish new parameters for updating stored subscriber identification, where the new parameters are received from the new network operator over the secure connection and to check integrity of the new parameters, and a transmitter configured to stop a connection to the network and to reestablish the connection using the new parameters. The apparatus may further include a storage device configured to store the new parameters in parallel to the stored parameters and to prioritize the new parameters. The apparatus may be a machine-to-machine terminal. The new parameters include changes in a universal subscriber identity module. The new parameters may result in a change from an old network operator to the new network operator.

The processor may be configured to compute a session key using either a hash or a reverse hash; establish an authentication and key agreement, or use public key cryptography with private and public signing keys.

The receiver may be configured to receive a token including the new parameters over the secure connection; and the processor may be configured to verify the token. The token may include an identifier of the new network operator, and where processor is configured to analyze the identifier.

### BRIEF DESCRIPTION OF THE DRAWINGS

For proper understanding of the invention, reference should be made to the accompanying drawings, wherein:

FIGS. 1A-1C are flow charts illustrating steps in a method for universal subscriber identity module ((U)SIM) provisioning for machine-to-machine (M2M) communications in accordance with an embodiment of the present application;

FIG. 2 is a schematic diagram that illustrates a system for implementing the (U)SIM provisioning method of FIGS. 1A-1C in accordance with an embodiment of the present application;

FIG. 3 is a process flow diagram that illustrates messaging in the system of FIG. 2 when implementing the (U)SIM provisioning method of FIGS. 1A-1C in accordance with an embodiment of the present application;

FIG. 4 is a flow chart illustrating steps in a method for universal subscriber identity module ((U)SIM) provisioning for machine-to-machine (M2M) communications via an existing network operator in accordance with another embodiment of the present application;

FIG. 5 is a schematic diagram that illustrates a system for implementing the (U)SIM provisioning method of FIG. 4 in accordance with an embodiment of the present application;

FIG. 6 is a process flow diagram that illustrates messaging in the system of claims 2 when implementing the (U)SIM provisioning method of FIG. 4 in accordance with an embodiment of the present application;

FIG. 7 is a schematic diagram of the components of system for implementing the (U)SIM provisioning, such as illustrated in FIGS. 2 and 5, in accordance with embodiments of the present application;

FIG. 8 is a schematic diagram that illustrates a (U)SIM provisioning system for in accordance with another embodiment of the present application; and

FIGS. 9-10 are process flow diagram that illustrates messaging for (U)SIM provisioning for M2M communications in the system of FIG. 8 in accordance with another embodiment of the present application.

### DETAILED DESCRIPTION OF THE PREFERRED EMBODIMENT(S)

In response to these and other needs, embodiments of the present invention provide solutions that address the problem of securely and remotely updating a (U)SIM with authentication and key agreement parameters. These solutions allow moving the subscription of an M2M terminal from one operator to another, without causing the costs involved with a manual update.

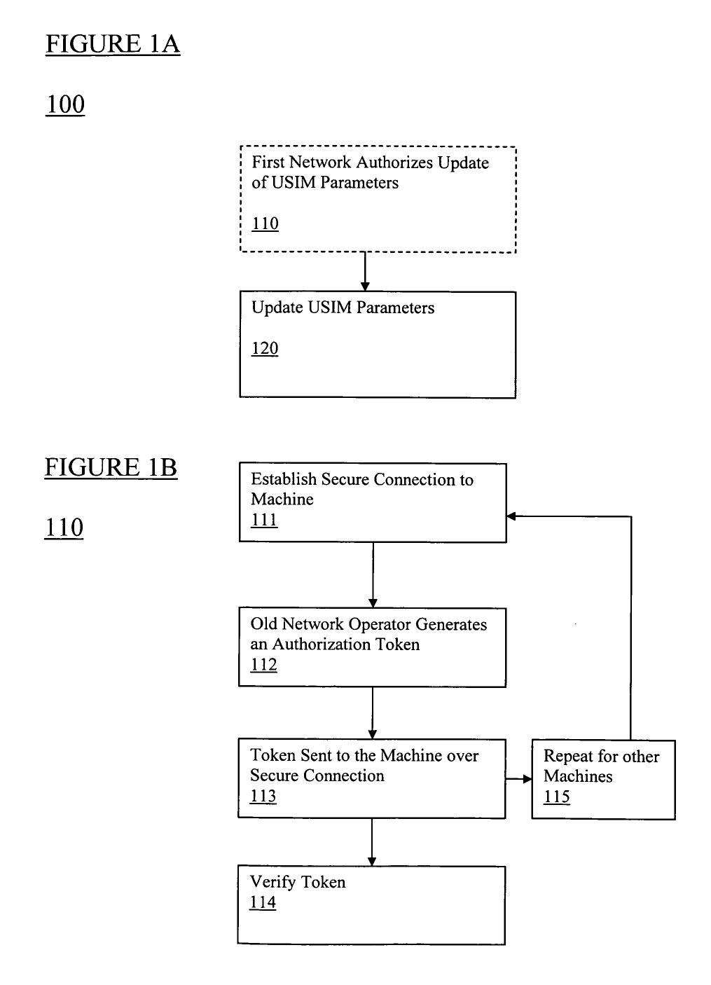

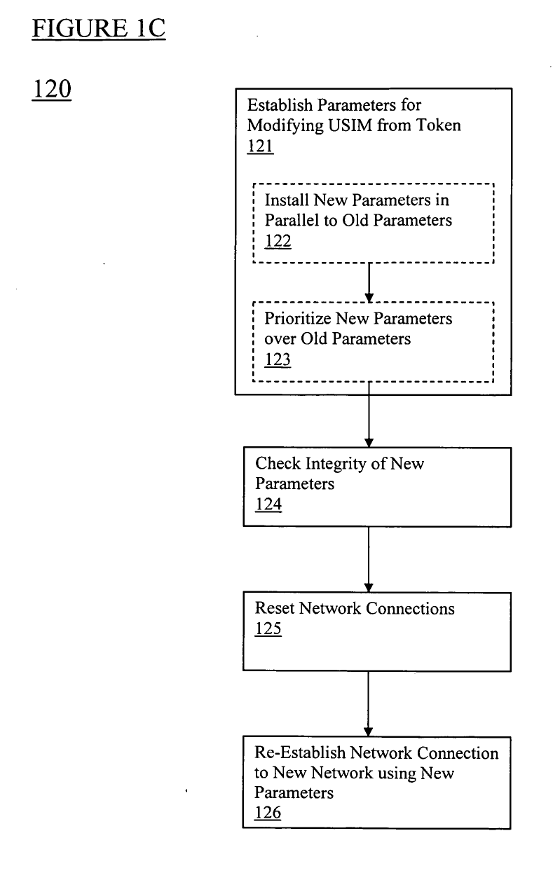

FIGS. 1A-1C are flow charts illustrating steps in method 100 for (U)SIM provisioning in M2M communications in accordance with an embodiment of the present application. In the (U)SIM provisioning method 100, a security mechanism involves a first, current network operator from which the M2M owner is cancelling service. The M2M Owner makes the decision to switch subscription and the following discussion provides an example in which M2M owner wants to transfer a subscription in a machine, belonging to a first network to a destination network. In step 110, the first network authorizes the update of the (U)SIM parameters. This authorization gives the first network control over potentially unwanted or illegal transfers of subscriptions to another network. Authentication step 110 is optional, because in some situations such involvement of the old network operator is unwanted or unavailable.

Referring now to FIG. 1B, the authentication step 110 starts by establishing a secure connection to the M2M machine in step 111 so that the machine is accessible. Step 111 is typically accomplished using the subscription in the first network. The first network then generates an authorization token in step 112 using conventional techniques. For example, the authorization token can be based, for example, on GBA [TS33.220], Kerberos, SAML, a one-time pass-phrase, public key cryptography, the secret subscriber key Ki, etc. The secret subscriber key, Ki, is used to calculate authentication vectors. The authorization token is then sent from the first network to the machine in step 113. More specifically, the token is sent to the (U)SIM.

As described in greater detail below, the token may be sent to the machine directly or via the machine owner. The data to be updated might be shipped to the machine using application level protocols or Open Mobile Alliance Device Management. The token is presented to the machine, which verifies the token, in step 114. In step 114, if the verification is successful, the M2M machine may grant permission to update certain fields on (U)SIM with destination specific information such as the algorithm, keys, IMSI, etc. An IMSI is a unique identifier of the subscriber in the new network or, more accurately, the specific terminal of the subscriber. Similarly, authentication and key agreement algorithms may be used in the method or, alternatively, some parameters that allow customization of the authentication and key agreement algorithms.

Continuing with FIG. 1B, the authentication process 110 may repeat with other machines, such as other M2M devices. In this way, the appropriate token(s) may be sent to multiple devices. The network should support moving of large “subscription bulks,” such as rental car company or similar use case, where this moving of large subscription bulks occurs without or with minimal manual interaction on the subscriber database.

In another implementation, the old operator 220, when creating the token in step 112, can imbed a name, or other identifier for the new operator. This way, the mobile device 250, after receiving the token can verify the token by matching the token and the update information.

After the (U)SIM has authorized the arrival of updates, the actual update of the mobile device is done, using the information in the Token to establish parameters for modifying the (U)SIM in step 121. In particular, the transmitted token received by the device includes the new parameters such as the IMSI, keys, authentication and key agreement algorithms and/or parameters, etc. for converting a (U)SIM-1 into a (U)SIM-2. Preferably, this update is done in two steps. In a first step the new parameters are installed parallel to the old ones in step 122 and an indication is sent that the new set has priority in step 123. For example, the old set may be flagged to expire after the next reset of the equipment. This proceeding allows implementation of a fallback to the old parameters, in case something goes wrong

Similarly, in step 121, a company may equip a phone with several software based (U)SIMs or ISIMs for roaming purposes. The company may then switch operator for example, by activate a different (U)SIM or ISIM. In this implementation, the token does not contain the necessary parameters, but instead directs the device to select from the different (U)SIM or ISIM already present on the device.

The terminal and/or (U)SIM may check the integrity of the new parameters, step 124. As some of the parameters contain confidential information, such as a. secret key, the parameters should be sent encrypted. Then, the machine resets at least its network connection in step 125.

On re-establishment of the network connection in step 126 the parameters of the destination network are used. On successful connection establishment, the new parameters will permanently replace to old parameters, making the transfer to the new network final. The (U)SIM is transformed in an authentication and key agreement device for the new network.

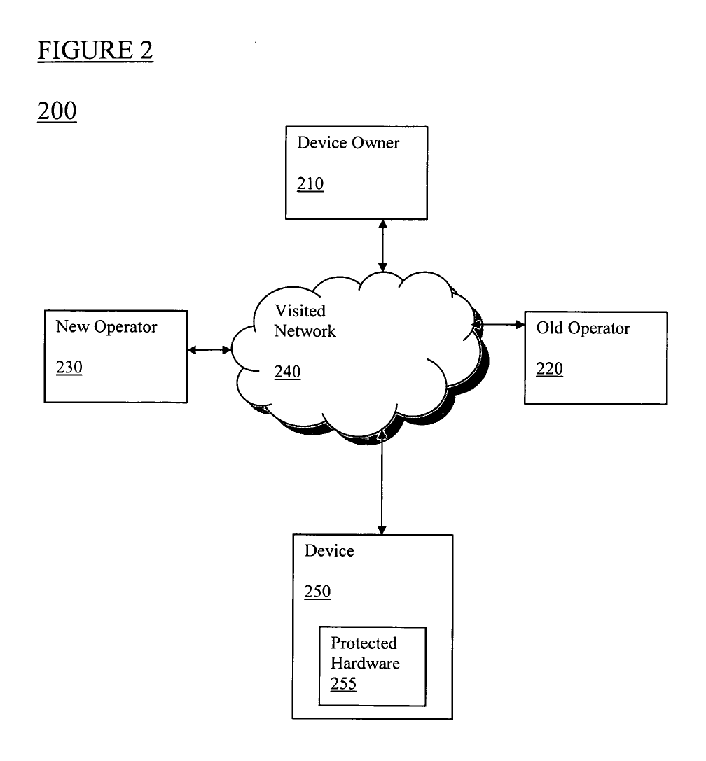

Referring now to FIG. 2, a (U)SIM provisioning system 200 is presented that operates as described above in the discussion of the (U)SIM provisioning method 100. The system 200 includes a device owner 210. The M2M Owner makes the decision to switch subscription. The system 200 further includes an old operator 220 and a new operator 230, whereby the old that establishes the connection to the M2M machine to initiate the (U)SIM provisioning. The old operator must not prevent subscription switch, but will only give minimal support, and the old operator should protect subscription from fraudulent transfers. It is noted that the new operator will not have access to subscriber related data of old operator (privacy issues etc.). In particular, secret subscriber Ki may be used for authentication of the subscriber, and will not be transferred to any third party.

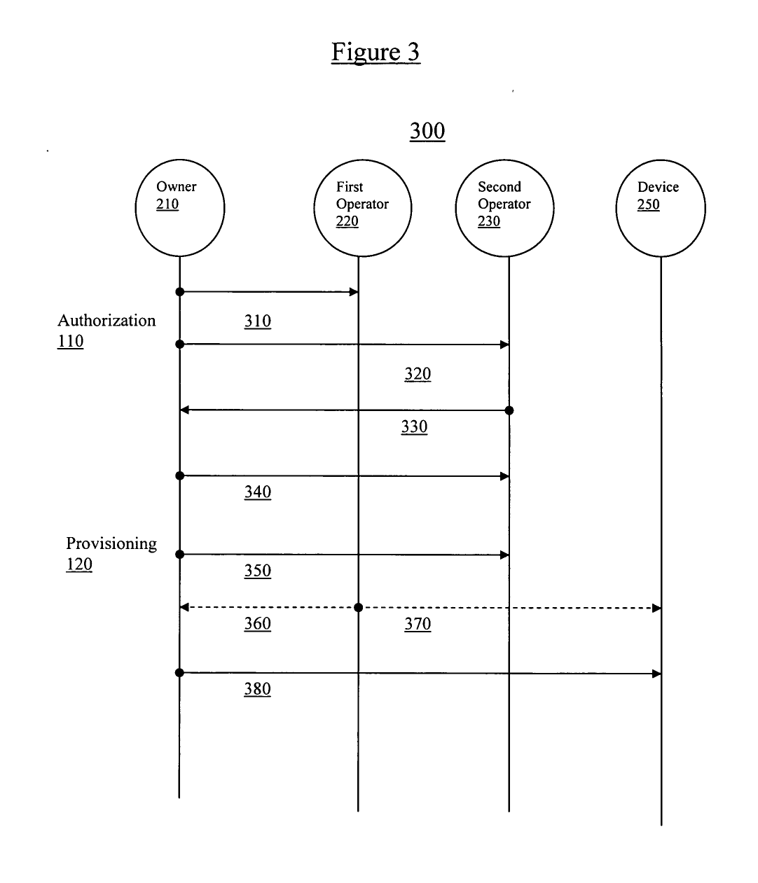

FIG. 3 is a process flow 300 that illustrates the transmission between the various components of FIG. 2, in accordance with the method of FIG. 1A-1C. The M2M owner 210 contacts both new and old operator 220 and 230 to fulfill all legal obligations involved in cancelling/taking a subscription, respectively, in communications 310 and 320. The new operator 230 provides M2M Owner with new batch of IMSI, in communication 330. In response, the M2M Owner 210 then provides information (at least MCC∥MNC, possibly all IMSI) from old operator to the new operator in communications 350.

Continuing with FIG. 3, the old operator 230 calculates for every machine a token the message that includes a hash with replay_protection, new MCC∥MNC or IMSI, Ki). The old operator 230 in communications 360 then sends all the tokens to machine owner 210 or, alternatively, directly to the machine in communications 370. For example, plain text values of replay_protection may be also included in this communication 360 and 370. Otherwise, if the tokens were not sent directly towards the machine, the machine owner forwards them to the machine in communications 380.

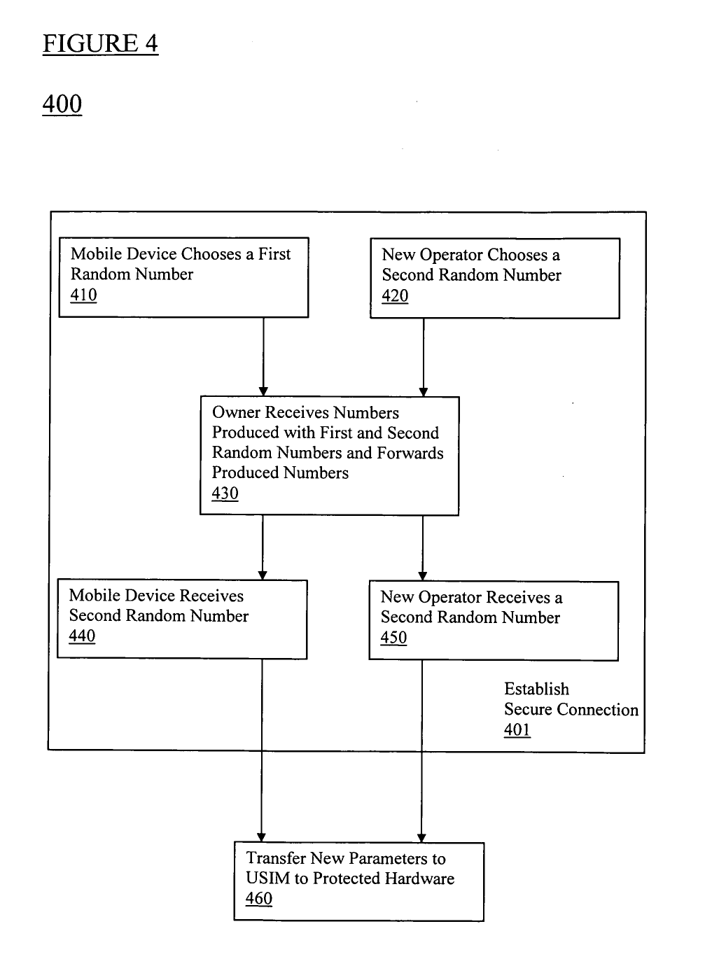

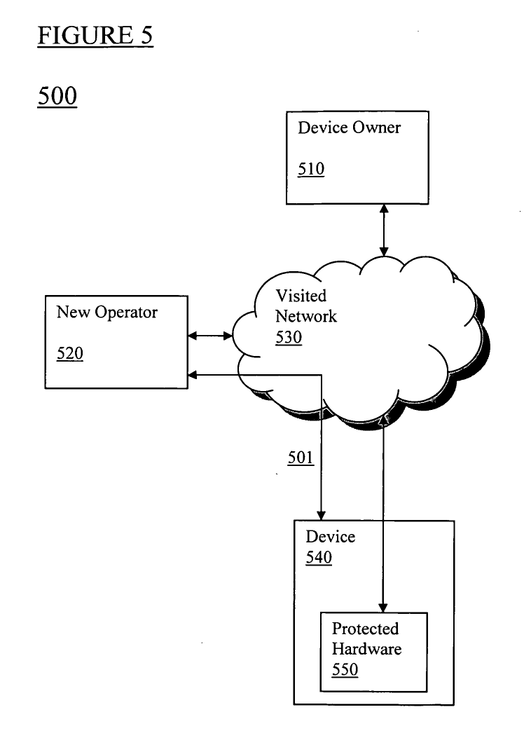

The machine 250 verifies the token against replay attacks. Protected hardware 255 in the device 250 to check the hash value of the token. If everything is acceptable, the (U)SIM in the device 250 is put in a state in which it is willing to implement new parameters, as described below in FIG. 4 in the transfer parameter method 400.

In FIG. 4, both the M2M machine and new operator's HSS-HLR-AUC choose a random number in step 410 and 420, and under this number to calculate the power of a certain number g. Move specifically, the M2M Machine chooses a number Rm and calculates g^{Rm}; and the HSS-HLR/AuC chooses a number Rh and calculates g^{Rh}. The results are sent to the machine owner in step 430. Because the machine owner has a trusted communication channel towards both his machine and the new operator, the owner is relatively certain that no third party generated either of these two numbers. The machine owner 210 then forwards both numbers to the other party (g^{Rh} to the M2M machine, g^{Rm} to the new HSS-HLR/AuC), in steps 440 and 450 Again, due to the trusted communication links, it is made sure that no third party interferes.

For example, the HSS-HLR/AuC in the new operator calculates (g^{Rh})^{Rh}. M2M calculates (g^{Rh})^{Rm}. Because (g^{Rm})^{Rh}=(g^{Rh})^{Rm}, both HSS-HLR/AuC and M2M machine now have a key code number that is unknown to the public and that can be used to derive a symmetrical session key. This session key can encrypt all secret information HSS-HLR/AuC and M2M machine need to exchange (such as a new Ki, new algorithm parameters, new algorithm, etc.) in step 460.

These calculations are typically carried out in a finite field in which it is infeasible to calculate logarithms. The number g should be a generator of this finite field, such that each different number pairs N and g^{N} give a different result. As described below, the calculations are typically carried out in protected HW in the device 250. The value for g is not secret. In the flow above, g is considered to be a predefined value. In another embodiment, the machine 250 and HSS-HLR/AuC in the new operator 230 agree explicitly upon a value for g (with machine owner as intermediary). Also the finite field in which the calculations are performed are preferably fixed. This fixing of the finite field can be done also either explicitly or implicitly. In order to provide an acceptable amount of security, the finite field is preferably a relatively large, for example 2048 bits or larger.

A (U)SIM parameters transferring system 500 in accordance with embodiments of the present application is illustrated in FIG. 5. Based on the (U)SIM provisioning system 200 of FIG. 2, the (U)SIM parameters transferring system 500 includes a device owner 510, a new operator 520, a visited network 530, and a device 540 that include the protective hardware 550, such as a UICC smart card that contains the (U)SID application for UMTS mobile telephony. These components in FIG. 5 correspond to the similar component in FIG. 2. One difference is optionally establishing a secure connection 501 between the device 540 and the new operator 520.

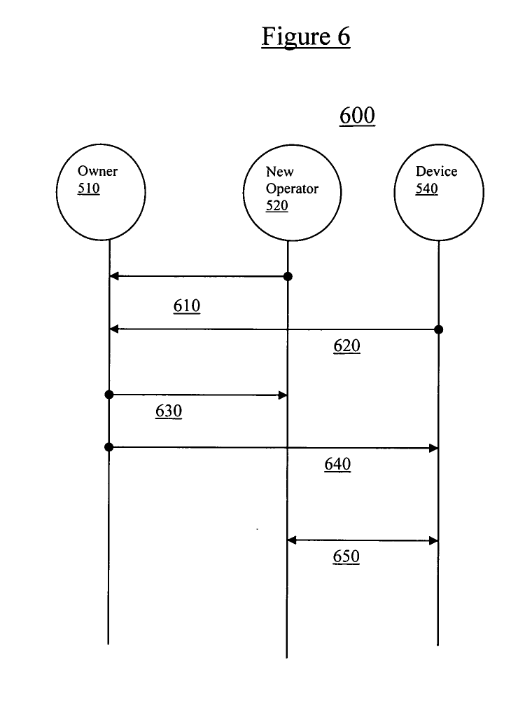

Referring now to FIG. 6, a process flow 600 relates to the transferring of new parameters to a (U)SIM. In communications 610 and 620, the operator 520 and the M2M machine randomly select numbers and derive values from these numbers. The machine owner 510 then forwards both numbers to the other party (g^{Rh} to the M2M machine, g^{Rm} to the new HSS-HLR/AuC) of the new operator, in communications 630 and 640 to establish a secure connection. The secured channel, such as 501, is then stable and may be used to transfer new parameters to the (U)SIM of the mobile device in message 650.

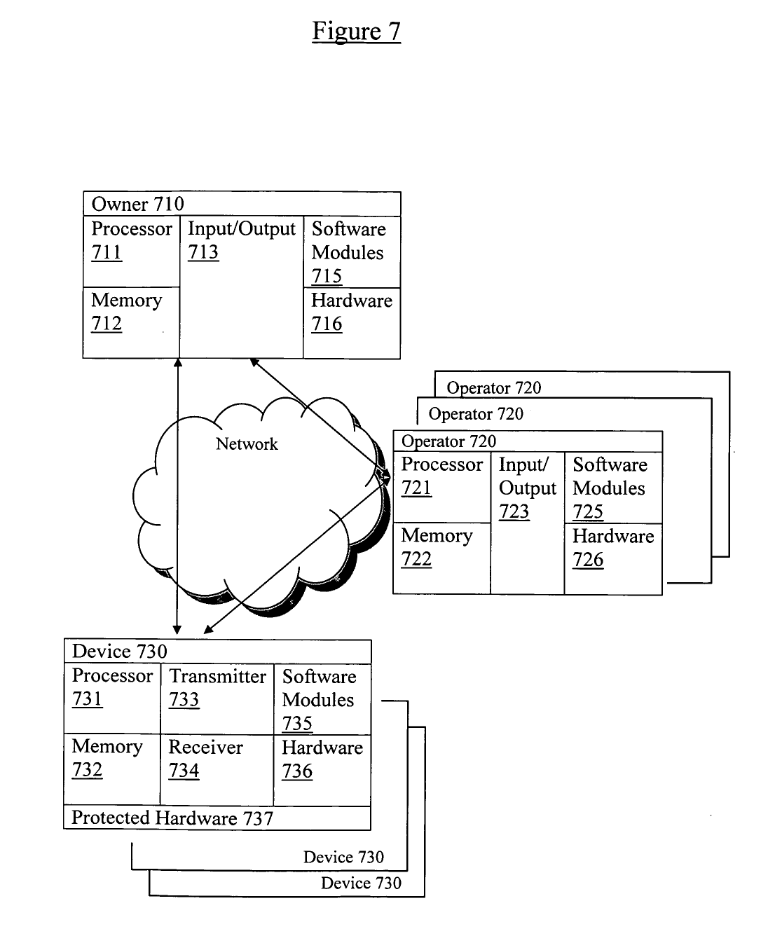

A (U)SIM provisioning system 700 in accordance with embodiments of the present application is presented in FIG. 7. In FIG. 7, an owner 710 connects to both to one or more operators 720 and to a device 730, such as an M2M component, as needed to exchange the token with the needed data for updating the USLP to reflect a change in the operators 720. As illustrated in FIG. 7, the owner 710 may include a processor 711, memory 712, and an input and output device 713. The owner 710 may further include software 715 and related hardware 716 for performing the functions related to the broadcast of signals, as disclosed in the present application. Thus, the processing of the messages to be transmitted may be performed, as needed by circuitry in the hardware 716 or software 715.

Likewise, the operator 720 may include a processor 721, memory 722, and input and output device 723. The destination 720 may further include software 725 and related hardware 726 for performing the functions related to the receiving and decoding of the broadcast of signals, as disclosed in the present application.

The device 730 may also include a processor 721, memory 722, and input and output devices 723 and 724, as needed to receive and forward a message. The relays 730 may further include software 725 and related hardware 726 for performing the various functions related to the receiving and decoding of the broadcast of signals, as disclosed in the present application. For example, the relays may receive and store messages to be transmitted, and access the memory and transmit the stored messages. Thus, the processing of the messages to be transmitted may be performed, as needed by circuitry in the hardware 726 or software 725.

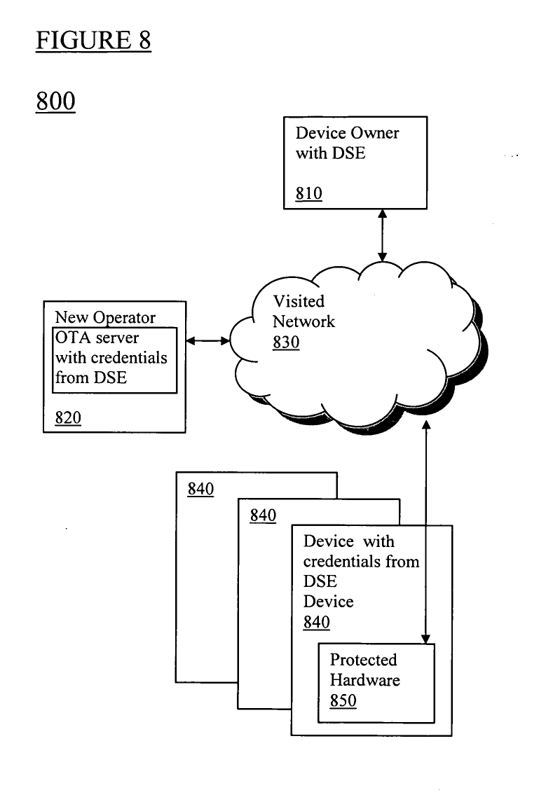

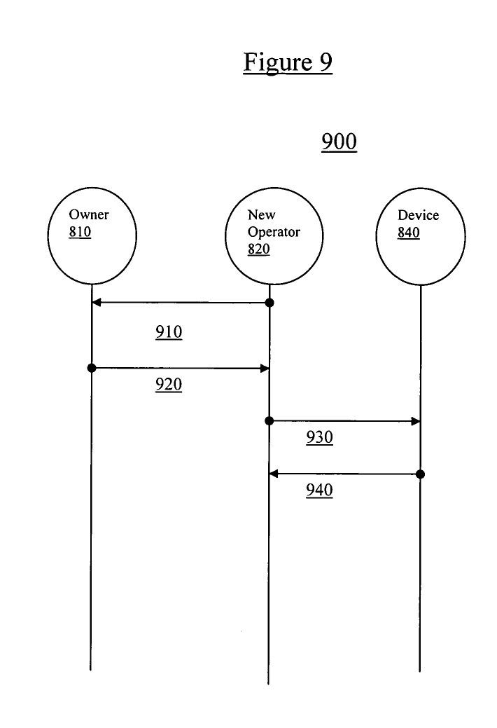

In another embodiment of the present application present at FIG. 8, a system 800 for provides a security mechanism using an M2M download security environment (DSE). In system 800, the M2M download security environment (DSE) is allocated to every M2M terminal 840. This DSE could be stored, for example, on a CD for several M2M terminals 840 and given to the M2M terminal owner when he purchases the terminals from the manufacturer, or it could be distributed in some other fashion, such as, via email or file transfer or web download, and stored in any form of database or file.

The M2M terminal owner 810 could also let the DSEs for his M2M terminals 840 be handled by an agent, such as a service provider specialized in this task, or a mobile network operator. The M2M terminal owner 810 would then, however, have to trust this other entity to handle the DSE securely.

As described below, in the system 800 of FIG. 8, the new network operator 820 may avoid a need to get any approval, such as for the download of a new (U)SIM to the M2M terminal 840, or involve the M2M terminal in any other way except for providing connectivity. Another main advantage of this approach of FIG. 8 is that download to M2M terminals 840 can be secured without any central institution and under full control of the M2M owner 810.

The DSE may contain security credentials mirrored in the M2M terminal 840 which can be used to protect download of (U)SIM parameters from an Over-the-air (OTA) download center, associated with an the new operator 820, on to the M2M device. The DSE may also contain a private/public key pair for signing information sent to an operator. The public key may be accompanied by a certificate.

In at lease one configuration, security credentials needed to secure a download procedure are stored on the DSE Such credentials could be realized by one entry from the following non-exhaustive list: session key SK would then be computed as SK=HASH (RK, COUNTER value, etc. The validity of SK could be limited, and this limit could consist in a maximum duration, or a number of well-defined transactions, or one session between an OTA center and M2M device. Another important limit which could be set to limit the use of SK is that SK becomes invalid after as soon as the M2M terminal 840 receives a message protected by a session key computed with a higher COUNTER value as input. In order to prevent replay attacks, the M2M terminal 840 stores the latest COUNTER value used, and accept only higher COUNTER values.

Only SK and COUNTER, not RK would be disclosed by M2M owner 810 to the network operator 820. In this way, the network operator would not be able to control the M2M device forever, but only within the defined limits for the use of SK. Instead of counters, also other time-variant parameters, such as time-stamps could be used.

In another implementation, in order to avoid forcing the M2M terminal owner 810 from compute the session keys in a potentially insecure environment, the DSE may contain a sufficiently large number of independent (session key, COUNTER) pairs. The M2M terminal owner 540 could then hand such a pair to an operator of his choice when the M2M terminal owner 810 wants to obtain a subscription from this operator. The M2M terminal 810 would still need to store only RK and could compute the session key from RK and the received COUNTER value. COUNTER could also be another time-variant parameters, such as a time-stamp.

In another implementation, a hash chain is defined as follows: there is a secret root key RK, and a function HASH. Session keys SK(n) are then obtained be the formulae SK(0)=RK; SK(n)=HASH (SK(n−1)). Session keys SK(n) would have to be released first, then SK(n−1) etc., so one has to be sure to start with a sufficiently high n. All considerations on limits in a1) would apply accordingly. The idea in a2) would also apply accordingly.

In another implementation. this variant uses an implementation of an identical or modified copy of UMTS AKA in DSE and M2M terminal 830. In this way, the DSE would have the AKA functionality of an Authentication Center AuC (but not necessarily the same HW/SW structure as an AuC), the OTA server would have the functionality of a VLR or SGSN. For more information on the roles of AuC, VLR and SGSN, see, for example, 3G TS 33.102. The advantage of this configuration generally is a stronger freshness guarantee if the DSE generated the RAND in real time, and a more flexible replay protection mechanism through the use of the array mechanisms as defined in TS 33.102.

Similarly, the DSE could contain a number of pre-computed AKA authentication vectors, which could be handed to different operators one after the after. AuC functionality would not be required to be executed by the DSE 810.

In another variation, public key cryptography and, more specifically, uses a private signing key on the DSE for which the M2M terminal has the public verification key, and use of a public encryption key on the DSE for which the M2M terminal has the private decryption key. It would be possible to reveal the signing key to network operator 820. Then, the DSE would not have to be involved online in the download procedure. But this revelation of the signing key may be undesirable. Then, the DSE would have to be involved online in the signing process, as opposed to alternatives presented above. For a possible use of public key cryptography to protect the download of secret information, in particular secret cryptographic keys, See, for example. the DSKPP IETF.

In another configuration, several copies of private signing and public encryption keys could be stored on the DSE. Then, the corresponding public verification key and private decryptions keys may be stored on the M2M terminal 840.

Combination of these credentials from the above described embodiments may also be used. In one example providing authorization, public key cryptography may be used together with DSKPP or with OMA DM (Device Management, cf. http://www.openmobilealliance.org/), but the authorization of the OTA server to the M2M terminal 840 would be achieved using a one-time secret credential obtained, for example, according for example, to results of a hash table. In this example, the M2M terminal owner 810 would obtain a spare (SK, COUNTER) according to using a hash table or storing multiple points and from the DSE and give it to the operator of the OTA server, which sends it to the M2M terminal. The M2M terminal would then consider the OTA server as authorized to download information to the terminal if the terminal can obtain SK from RK and COUNTER or if some token protected with SK as input can be verified by the terminal. The use of a DSE for securing the download of a (U)SIM to a n M2M terminal is illustrated FIG. 8:

Referring now to FIG. 9, a process flow 900 depicts one embodiment that reveals the signing key to the operator. In communications 910, an OTA server requests derived credentials from M2M terminal owner. Next, the M2M terminal owner 810 sends derived credentials to OTA server in communications 920. These derived credentials would typically be SK and COUNTER for alternative, SK(n) and n for alternative b), and a UMTS AKA authentication vector, as described in 3G TS 33.102, or a private signing and public encryption key. The information should be sent over a confidential channel. The confidentiality of this channel may be obtained by various means including email encryption, for example, with PGP, encryption with a public key of the operator obtained by the terminal owner in a trustworthy manner, courier, etc. The information sent when deriving credentials may optionally be signed by a private signing key in the DSE and may include the corresponding certificate.

Continuing with FIG. 9, the OTA server then encrypts and signs/integrity-protects download information with the credentials received in step 2, and sends it to M2M terminal 840 in communications 930. In addition, for a hash chain, a COUNTER is sent; for a reverse hash train, the value n is sent; for a UMTS AKA, variables RAND and AUTN are sent. Further information may be sent as required by the security protocol with which the credentials are used such as TLS (RFC 2246) or pre-shared key TLS (RFC 4279) at www.ietf.org. The M2M terminal 840 then decrypts and verifies download information and sends confirmation to OTA server in communications 940.

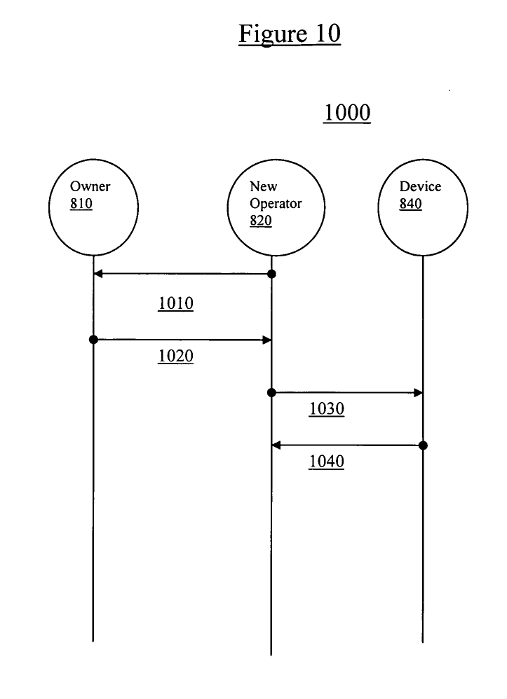

Process flow 1000 of FIG. 10 illustrates another configuration in which the signing key is not revealed to the operator. Instead, the OTA server sends a hash value of the download information to the M2M terminal owner in communications 1010. The owner verifies the origin of this hash value, and may use various means such as signed email, signature by the OTA server where the verification key is obtained by the terminal owner in a trustworthy manner, courier, etc. The M2M terminal owner encrypts and signs download information and sends it to OTA server in communications 1020. The OTA server sends information received from M2M terminal owner to M2M terminal in communications 1030. In the communications 1030, further information may be sent as required by the security protocol with which the credentials are used, such as TLS (RFC 2246) or pre-shared key TLS (RFC 4279). Then, the M2M terminal 810 decrypts and verifies download information and sends confirmation to OTA server in communications 1040.

While the above discussions refer to adapting (U)SIM for changing network operators, as a generalization, the same mechanisms could be applied to any set parameters to be updated in the (U)SIM. Likewise, as a further generalization, it is possible to use the invention also for other purposes besides M2M communication in a 3GPP context. For example, similar techniques may be used with any identity management system based upon the presence of identity specific parameters present in a tamper resistant memory, or with a MVNO (mobile virtual network operator) when changing from one network to another to avoid the requirement of changing the (U)SIM.

In one current application, M2M communications are used, for example, to track and trace products. For example, certain cars rental may be equipped with tracking devices to obtain the car's position for inventory purposes and to locate the car in case of theft. Similarly, M2M communications may be used for tagging relatively expensive tools and equipment, such as containers or tools in the building industry or oil industry. Typically, the M2M communications are used with relatively expensive goods where the high value of the product justifies the costs associated with the M2M-based tagging and the handling overhead, and the embodiments of the present application, as described above, may help to reduce these costs by minimizing maintenance costs associated with the M2M devices.

Using M2M communications for product tracking presents entails certain needs that are addressed through the embodiments of the present application. One aspect of M2M communications for product tracking relates to provide tamper and theft resistant mobile terminal associated with the device that includes the UICC. The tamper and theft resistant mobile terminal is conventionally provided by constructive measures, such as locking the entire M2M module within a secure enclosure and, in some cases, mounting the M2M module at places that are difficult to discover and/or access. This security requirement makes the M2M application relatively difficult to handle and, thus, even more expensive for the M2M user. For this and other reasons, the M2M user typically can access the M2M terminals only in certain instances, such as during maintenance of the tracked product. Only at these times can the user perform maintenance of the M2M equipment, including checking whether someone has tampered with the M2M equipment or swapping UICCs.

A second need for M2M communications for product tracking arises due to a need of the M2M users to have a reliable, long term functional and viable M2M application for the lifetime of a product. Toward this goal, it may be desirable for the M2M user to change the wireless communications subscription associated with the M2M device. For example, if tagged products are moved to a new location, a current service provider may no longer provide adequate in the new location. However, changing service providers in conventional configurations may be difficult with the conventional UICC configurations used in the M2M terminals due to a need to physically access and change the (U)SIM settings, especially when a M2M user has a substantial numbers of M2M terminals in the field. As described above, the user may have only limited access to the tagged products, and even when given this access, configuring the M2M terminal is difficult due to its hidden, secure configuration. Accordingly, embodiments of the present application address this need of providing a reliable, long term functional and viable M2M application for the lifetime of a product. by easing transitions between network operators as needed to control costs and to ensure improved service quality.

Overall, there may be many M2M applications where the above-mentioned problems related to securing the M2M terminals within a product while providing sufficient access to enable maintenance and service changes cannot be resolved. Thus, M2M terminals historically could be used for tracking and tracing of a large percentage of the current market goods, but that the embodiments of the present application may allow the M2M terminals to be applied on a broader basis.

In another application, M2M terminals may be used to product/servicing metering. In this application, the M2M performs functions related to transmitting information regarding the status and usage of a metered good or service. A metering device is usually untouched after installation for years. Again, the UICC should to be protected against theft and removal to prevent use of the connection to the utility for fraudulent purposes, and consequently it would be generally difficult to access the UICC.

Furthermore, changing the utility (and probably the mobile network operator) may face obstacles. While the M2M terminal in this application requires no mobility since the device mounted to a fixed location, high flexibility is desired in the allocation of the M2M terminal in case of utility change and/or mobile network operator change. The most complex case occurs when a utility customer changes his utility configurations, such as switching between power suppliers. If the new power supplier happens to contract with a different wireless network operator, either complex accounting mechanisms are needed or the utility must send out a service person to change the (U)SIM. Both solutions are relatively costly and prone to misallocations. Accordingly, embodiments of the present application address this need of providing a reliable, long term functional and viable M2M application for the lifetime of a product by easing transitions between network operators as needed to control costs and to ensure improved service quality.

For example, in embodiments of the present application, a company may equip a phone with several software based (U)SIM/ISIM's for roaming purposes. The company may then switch operator, for example by activating a different (U)SIM/ISIM, in one of the roaming countries. This would result in the same mechanism as in metering.

Similarly, embodiments of the present application ease transitions between network operators as needed to control costs and to ensure improved service quality to allow the network to support moving of large “subscription bulks.” For example, embodiments of the present application allow a group of M2M devices to change operators as needed, for example, to change operators for M2M devices used by a rental car company tracking its fleet, without or with minimal manual interaction on the subscriber database.

It should be noted that in the context of this invention report we focus on machine subscriptions in the sense that the credentials of those subscriptions (algorithms, keys) may also be implemented in software in a secure environment. The present invention is not restricted to use with a UICC smart card. In particular, the present application, when talking about (U)SIM (and ISIM), is directed to a combination of software and hardware that complies with the functions specified in 3GPP TS 31.102 ((U)SIM) or 3GPP TS 31.103 (ISIM).

In conclusion, the present application provide several embodiments to provision USIM information. In certain embodiments, authentication is done through a current operator in the switch to the new provider, and in other embodiments of the present application, the authentication is done without involving the current operator. Both solutions provide significant advantage over the conventional solution. By limiting the choice of cryptographic algorithms, neither of the embodiments requires central storage. Thus, none of the embodiments presented in the present application require the introduction of central entity such as a globally working registration service.

The involvement of the current operator may be advantageous in that the involvement of the first network operator can provide an additional instance of control against misuse of the USIM download functionality.

Conversely, using the current network operator as a trusted intermediary may be somehow problematic for a number of reasons. For example, using the current network operator as an intermediary may reduce security. Also, the M2M terminal owner may be dissatisfied with the first network operator and may have lost trust. Moreover, the first network operator may no longer be able or willing to cooperate in this process. For example, the operator may have gone out of business.

For embodiments without involvement of the current operator, the machine owner 810, or an associated agent, stores the DSE. For example, a specialized service provider may help to securely store the DSE.

Moreover, one having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method for remotely updating stored subscriber identification parameters over a wireless network, the method comprising:
establishing new parameters from a new operator for updating stored subscriber identification;
checking integrity of the new parameters using data received from an old network operator;
stopping a connection to the network; and
reestablishing the connection using the new parameters.

2. The method of claim 1, wherein the new parameters relate to a new network operator

3. The method of claim 1, wherein the establishing of the new parameters comprises:
storing the new parameters in parallel to the stored parameters; and
prioritizing the new parameters.

4. The method of claim 2, further comprising:
receiving authorization to update the parameters.

5. The method of claim 4, wherein the receiving of the authorization to update the parameters comprises:
accepting a secure connection from the old network operator;
receiving a token from the old network operator, wherein the token comprises the new parameters; and
verifying the token.

6. The method of claim 5, wherein the token comprises an identifier of the new network operator, and wherein the verifying of the token comprises analyzing the identifier.

7. The method of claim 1, wherein the method is performed by a machine-to-machine terminal.

8. The method of claim 1, wherein the method is performed by multiple devices.

9. The method of claim 1, wherein the new parameters comprise changes in a universal subscriber identity module.

10. The method of claim 2, wherein the new parameters result in a change from the old network operator to the new network operator.

11. The method of claim 1, further comprising:
forwarding a first random number;
receiving a second random number;
accepting a secure connection based on the first and second random numbers; and
receiving the new parameters over the secure connection.

12. The method of claim 11, wherein the method is performed by a device, wherein the second random number is produced by a new network operator, and wherein a computer associated with an owner of the device exchanges the both the first and the second random numbers between the device and the new network operator.

13. An apparatus for remotely updating stored subscriber identification parameters over a wireless network, the apparatus comprising:
a storage device configured to store the subscriber identification parameters;
a processor configured to establishing new parameters for updating subscriber identification and to check an integrity of the new parameters using data received from a current network operator; and
a transmitter configured to stop a connection to the network and to reestablish the connection using the new parameters.

14. The apparatus of claim 13, wherein the storage device is further configured to store the new parameters in parallel to the stored parameters to prioritize the new parameters.

15. The apparatus of claim 13, wherein the storage device is further configured to remove the new parameters, and wherein the transmitter is further configured to restore the connection to the network using the stored parameters.

16. The apparatus of claim 13, further comprising:
a receiver configured to receiving authorization to update the parameters.

17. The apparatus of claim 16, wherein the receiver is further configured to accept a secure connection from the current network operator, and to receive a token from the current network operator, wherein the token comprises the new parameters; and wherein the processor is configured to verify the token.

18. The apparatus of claim 17, wherein the token comprises an identifier of a new network operator, and wherein the processor verifies the token by analyzing the identifier.

19. The apparatus of claim 13, wherein the apparatus comprises a machine-to-machine terminal.

20. The apparatus of claim 19, wherein the apparatus comprises a meter.

21. The apparatus of claim 19, wherein the apparatus comprises a tracking device.

22. The apparatus of claim 13, wherein the new parameters comprise changes in a universal subscriber identity module stored in the apparatus.

23. The apparatus of claim 13, wherein the new parameters result in a change from the current network operator to a new network operator.

24. The apparatus of claim 14,
wherein the processor is configured to produce a first random number and a transmitter is configured to send the first random number to the network;
wherein the receiver configured to receive a second random number, accepts a secure connection based on the first and second random numbers; receives the new parameters over the secure connection.

25. The apparatus of claim 24, wherein the second random number is produced by a new network operator, and wherein a computer associated with an owner of the apparatus exchanges the both the first and the second random numbers between the apparatus and the new network operator.

26. A method for remotely updating stored subscriber identification parameters over a wireless network, the method comprising:
accepting a secure connection from a new network operator;
establishing new parameters for updating stored subscriber identification, wherein the new parameters are received from the new network operator over the secure connection;
checking integrity of the new parameters;
stopping a connection to the network; and
reestablishing the connection using the new parameters.

27. The method of claim 26, wherein the establishing of the new parameters comprises:
storing the new parameters in parallel to the stored parameters; and
prioritizing the new parameters.

28. The method of claim 26, wherein the accepting of the secure connection comprises: computing a session key using either a hash or a reverse hash, establishing an authentication and key agreement, or using public key cryptography comprising private and public signing keys.

29. The method of claim 26, wherein the receiving of the authorization to update the parameters comprises:
receiving a token, wherein the token comprises the new parameters; and
verifying the token.

30. The method of claim 29, wherein the token comprises an identifier of the new network operator, and wherein the verifying of the token comprises analyzing the identifier.

31. The method of claim 26, wherein the method is performed by a machine-to-machine terminal.

32. The method of claim 26, wherein the method is performed by multiple devices.

33. The method of claim 26, wherein the new parameters comprise changes in a universal subscriber identity module.

34. The method of claim 26, wherein the new parameters result in a change from an old network operator to the new network operator.

35. An apparatus for remotely updating stored subscriber identification parameters over a wireless network, the apparatus comprising:
a receiver configured to accept a secure connection from new network operator;
a processor configured to establish new parameters for updating stored subscriber identification, wherein the new parameters are received from the new network operator over the secure connection and to check integrity of the new parameters; and
a transmitter configured to stop a connection to the network and to reestablish the connection using the new parameters.

36. The apparatus of claim 35, further comprising:
a storage device configured to store the new parameters in parallel to the stored parameters and to prioritize the new parameters.

37. The apparatus of claim 35, wherein the processor is configured to:
compute a session key using either a hash or a reverse hash;
establish an authentication and key agreement, or
use public key cryptography comprising private and public signing keys.

38. The apparatus of claim 35,
wherein the receiver is configured to receive a token comprising the new parameters over the secure connection; and
wherein the processor is configured to verify the token.

39. The apparatus of claim 38, wherein the token comprises an identifier of the new network operator, and wherein processor is configured to analyze the identifier.

40. The apparatus of claim 35, wherein the apparatus comprises a machine-to-machine terminal.

41. The apparatus of claim 35, wherein the new parameters comprise changes in a universal subscriber identity module.

42. The apparatus of claim 35, wherein the new parameters result in a change from an old network operator to the new network operator.

43. A computer readable medium for storing instructions to be executed on a process for implementing a method for remotely updating stored subscriber identification parameters over a wireless network, the method comprising:
accepting a secure connection from an old network operator;
receiving a token from the old network operator, wherein the token comprises the new parameters; and
verifying the token.
establishing new parameters from a new operator for updating stored subscriber identification;
checking integrity of the new parameters using data received from an old network operator;
stopping a connection to the network; and
reestablishing the connection using the new parameters.
